(19) United States
(12) Patent Application Publication
(10) Pub. No.: US 2006/0087496 A1
(43) Pub. Date: Apr. 27, 2006

(54) Electronic notepad

(76) Inventor: Vincent Maciejewski, Edmonton, NY (CA)

Correspondence Address: Vincent Maciejewski, 256 Burton Road, Edmonton, T6R 1P3, omitted

(21) Appl. No.: 10/904,148

(22) Filed: Oct. 26, 2004

(51) Int. Cl. G09G 5/00

(52) U.S. Cl. 345/173

(57) ABSTRACT

Disclosed is a system for capturing handwriting that provides all the usual functionality of a notepad, and stores what has been written on paper, or a writing area, in a computer memory and displays it on an associated screen. Said system permits retrieval and editing of previously stored handwriting.

Disclosed is a device that serves as an electronic notepad whereby the user writes on a sheet of paper, or another writing area, and the written information is recorded in a computer memory and displayed on an associated screen. The information can also be retrieved from the memory for viewing and editing.

Definition List 1

| Term | Definition |
|---|---|
| Transceiver | A device that acts as a receiver or |
| | as transmitter or as both. A |
| | transceiver can communicate with |
| | other transceivers using radio |
| | frequency waves or waves of other |
| | frequencies. |
| Pen | A writing device whose position is |
| | detectable by a computer. The |
| | device may use permanent ink or |
| | erasable ink or no ink. If the device |
| | uses erasable ink the device may |
| | also provide an eraser attached to |
| | end opposite to the end that |
| | writes. |
| Writing area | Paper, paper substitute, or another |
| | material such as plastic, that may |
| | be marked by a pen. |
| Notepad base | A sturdy rectangular plate or base |
| | of cardboard, plastic, metal, or |
| | other material, where paper and |
| | transceivers are attached. |
| Display base | A sturdy rectangular plate or base |
| | of cardboard, plastic, metal, or |
| | other material, where the display is |
| | attached. |
| Notepad computer | A computer comprising a CPU and |
| | a memory adapted to storing and |
| | retrieving handwriting information. |
| Page | A unit of handwritten information. |
| | Size of the unit is arbitrary and |
| | does not need to correspond to a |
| | physical paper sheet. |
| Stylus | The tip of the pen that comes into |
| | direct contact with writing sheet |
| | when the user writes. |

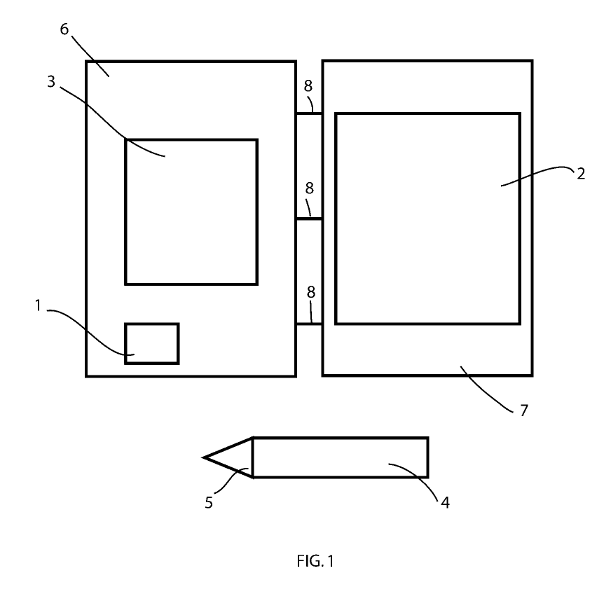

First preferred embodiment of the invention is shown in FIG. 1. According to FIG. 1, disclosed is a device that comprises a notepad computer 1 comprising a CPU and a memory, an associated screen 3, a writing area 2, a pen 4 comprising a stylus 5. The pen being a writing device used to write on the writing area.

The writing area being a paper notepad, a paper sheet, or another area where the user is expected to write using the pen.

When a human user writes with the pen, the notepad computer records what is being written and stores handwritten information in the computer memory associated with the notepad computer. There is also provided a means to display a page the user is currently writing on in real time as the user writes. This means is provided using the display.

In order for the notepad computer to store handwritten pages a means to transform stylus movements on the writing area into recorded handwriting data in the memory is provided.

In order for the notepad computer to record what is being written using the pen, the notepad computer must be able to locate the stylus and be able to determine if the stylus is touching the writing area. Hence a means to locate the stylus and a means to determine if the stylus touches the writing area are provided.

In order for the user to be able to read pages previously recorded, there is provided a means for retrieving and displaying pages previously recorded and stored.

In order for the user to be able to record more than one page, there is provided a means to indicate to the notepad computer that a new page has been begun.

In order for the user to be able to store and edit pages on a personal computer, a means to transfer stored pages to a personal computer is provided.

In order to search stored pages, a means to input a search pattern and a means to search stored pages using the pattern is provided.

As shown in FIG. 1, the display and writing area can be placed opposite each other on top of sturdy bases or plates, that open and close like a notebook. The display may be placed on a display base 6 and writing area may be placed on a notepad base 7 as shown in FIG. 1. Even though FIG. 1 shows the notepad computer to be placed on the display base it will be obvious to one skilled in the art that the notepad computer may be placed on either base. It will also be obvious to one skilled in the art that the display and the notepad computer can be integrated into one element. It will also be obvious to one skilled in the art that both bases can be combined into one.

In accordance with FIG. 1 the notepad base and the display base are placed opposite each other. The notepad and display bases can be connected using bindings 8. Such arrangement gives the user an impression that the present invention is similar in function to a regular notepad.

In order for a user of one device to be able to exchange previously recorded pages with a user of another device, there is provided a means to exchange pages from one device to another. Such means may be facilitated by providing a communication link between devices such as an infrared communications link.

In order to allow the user to store information available on another computer such as a personal computer, there is provided a means to print from a personal computer to the device. The device adapted to be available as a printer from the standard File>Print menu. Once information is printed to the device it becomes available for later viewing using the device.

In accordance with the first preferred embodiment, there is provided a method or system to facilitate the means to transform stylus movements into recorded data.

According to FIG. 1A, the system of FIG. 1, is further extended to comprise a plurality of transceivers 9 placed around the writing area, a plurality of transceivers 10 placed within the pen, and a pressure sensor 11 placed within the pen. Transceivers placed around the writing area being adapted to send or receive signals to or from transceivers located inside the pen, the signals being used to compute the position of the stylus.

The the pressure sensor operates in conjunction with a transmitter adapted to send status of the pressure sensor to the notepad computer.

It will be obvious to one skilled in the art that it may be possible to place one or more transceiver near or inside the tip of the stylus. All such embodiments are considered to be within the scope of the present disclosure.

It will also be obvious to one skilled in the art that transceivers 9, according to FIG. 1A, can be connected to notepad computer 1 in a variety of ways including copper wires.

A method to transform pen movements into recorded data is disclosed and comprises the following steps:
(1) User picks up the pen.
(2) Notepad computer receives signals from transceivers placed on notepad base and determines a position of the stylus.
(3) When the user presses the stylus against the writing area the pen transmits a signal to the notepad computer indicating that the stylus is pressed.
(4) Once the signal that stylus has been pressed is received by the notepad computer the notepad computer records position of stylus in memory whenever the user moves the stylus.
(5) When the user lifts the stylus the pen transmits a signal to the notepad computer indicating that the stylus has been lifted.
(6) Once the signal indicating that stylus has been lifted is received by the notepad computer the computer stops recording position of the stylus.

When this method runs its course, recorded data is in form of a bit map. However, it will be obvious to one skilled in the art that computer handwriting recognition algorithms can be used in order to transform the bitmap into text that can be stored in digital form.

In accordance with the first preferred embodiment of the present invention, a means to determine the position of the pen with respect transceivers placed in the vicinity of the writing area is provided.

There are a number of methods or systems that can be used to facilitate the means to determine the position of the pen, and hence the stylus, and all such methods or systems are intended to be covered by the present disclosure.

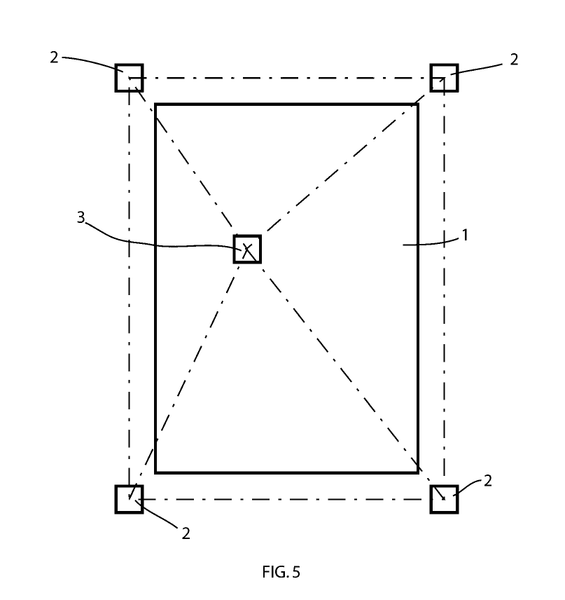

Once transmitters are placed inside the pen, the well known method of triangulation can be used. This method involves the placement of a plurality of receivers listening on signals from a transmitter placed inside the pen. The difference in time when signals are received by each of the receivers enables the computation of relative distance from each of the receivers and thereby determination of the position of the transmitter. For example, if two receivers receive a signal from a transmitter at the same time, then it can be determined that the distance from each of the receivers to the transmitter is equal. If one of the receivers receives the signal before the other receiver receives same signal, it can be determined that the transmitter is closer to the first receiver and it is known how much closer since the speed at which the signal travels is known. According to FIG. 5, it is enough to place four receivers 2 in the vicinity of the writing area 1 in order to determine the position of a transmitter 3 placed above the writing area. The coordinates of where the receivers are placed are well known. In accordance with the first preferred embodiment of present invention the transmitter will be placed inside a pen and will likely be positioned above the writing area. Since the position in three dimensions of the transmitter is described by three variables, and the distance to the receiver which first receives the signal is unknown, there are four unknowns that need to be solved for. It will be clear to one skilled in the art that in order to obtain four equations the construction of four triangles as shown by dashed lines in FIG. 5 will be sufficient.

It will be obvious to one skilled in the art the role of transmitters and receivers can be reversed to achieve a similar method of determining the position of the pen. Receivers can be placed inside the pen and transmitters can be placed around the writing area. Both arrangements are intended to be covered by this disclosure. Hence, throughout the disclosure, a transmitter or receiver is referred to using the more general term of transceiver.

In accordance with the first preferred embodiment of the invention, a means to determine an accurate position of the stylus is provided.

There are a number of methods or systems that can facilitate the means to determine position of the stylus and all such methods or systems are intended to be covered by present disclosure.

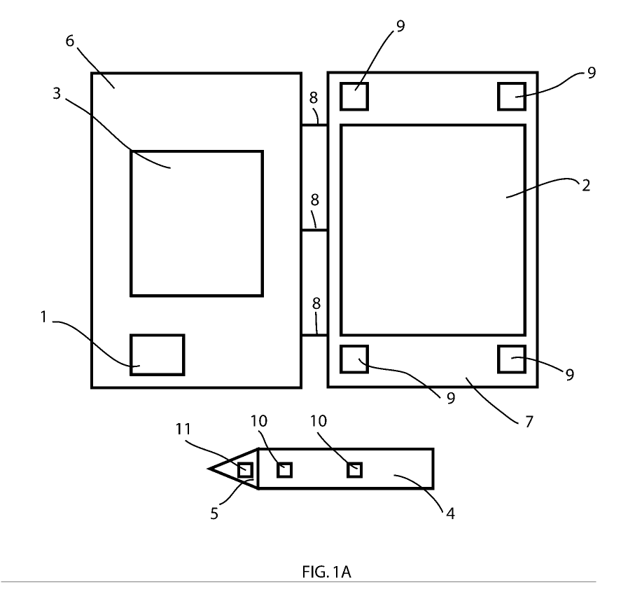

A system to determine an approximate position of the stylus is shown in FIG. 2. According to FIG. 2, placing two or more transceivers 2 inside a pen 1 will form an imaginary best fit straight line 6 through the transceivers once the position of the transceivers is determined. Given the length of the pen, it will be obvious to one skilled in the art that an approximate point 5 of where a stylus touches a writing area 3 can be determined. It will also be obvious to one skilled in the art that the approximate point will be at some distance from the exact point 4 of where the stylus 7 touches the sheet. It will also be obvious to one skilled in the art that increasing the number of the transceivers may reduce the distance the approximate point is from the exact point where stylus touches the sheet; hence improving accuracy of the approximation. It is practical to configure the transceivers inside the pen to be configured as transmitters; however, it is also possible to configure them as receivers.

In a further aspect of the first preferred embodiment a method for determination of an accurate position of where the stylus touches the writing area is provided. It is important to be able to compute an accurate position of the stylus in order to achieve a good record in the computer memory to what is being written. There are a number of methods that can be used to determine accurate position of where the stylus touches the writing area; however, all are intended to be within the scope of the present disclosure.

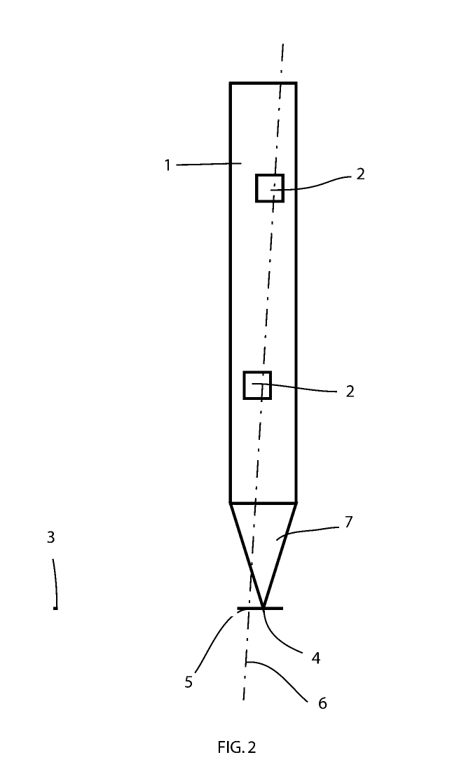

One such method is the method of calibration, where several visible mark spaces are placed in well known positions on the writing area. For example, a page might have small squares or circles, or other mark spaces, placed in a plurality of locations on the page as shown in FIG. 3. Before starting to write, the user will be asked to mark in each of the mark spaces 2 printed or otherwise placed on writing area 1. The position of the mark spaces is well know and is recorded in the computer memory beforehand so that when the user marks the mark spaces the notepad computer will be able to record the difference between the well known mark space positions and the computed mark space positions. The difference between computed and actual position will in turn enable the notepad computer to find the offset from the recorded and the exact position of where the stylus touches the writing area. When the user marks each of the mark spaces the computer computes the error offset. It will be obvious to one skilled in the art that one or more mark spaces may be placed on the writing area and their position is arbitrary as long as their position is well known and available to the notepad computer. It will also be obvious to one skilled in the art that following the calibration procedure handwriting can be recorded using coordinates relative to edges of the writing area as opposed to coordinates relative to where the transceivers placed around the writing area; given that distance from mark spaces to edges is known.

In accordance with the first preferred embodiment of the present invention there is provided a means to determine when the stylus touches the writing area.

There a number of methods or systems that can facilitate a means to determine when the stylus touches the writing area and all are intended to be within the scope of the present disclosure.

The determination of when the pen actually touches the writing area can be done using at least two methods and all such methods are intended to be covered by the scope of the present disclosure. In the first method, a pressure sensor is placed inside the stylus or the body of the pen itself. When the sensor is activated a signal is sent to the notepad computer indicating that the stylus has touched the writing area. The signal is sent using a transmitter associated with the sensor. In the second method, a sensor is placed underneath the writing area. When the sensor is activated a signal is sent to the notepad computer indicating that the stylus touched the writing area.

In accordance with the first preferred embodiment of the present invention there is provided a means to display and edit previously recorded pages.

There are a number of possible methods or systems of retrieving previously recorded pages and all are intended to be covered by this disclosure.

In one such method there is provided a scroll wheel or a scroll button connected to the notepad computer in order to scroll though previously recorded pages. Every time the scroll wheel or buttons are activated the next or previous page is displayed.

In another such method a scroll bar is provided on the display. In this method there is further provided an input mechanism to the notepad computer such as a mouse or touch screen with a stylus that allows the user to manipulate the scroll bar.

In another such method the user enters the page number to be displayed or the date when the page was created. In this method there is further provided an input mechanism to enter dates and numbers.

In another such method there is provided a method to attach annotations to previously recorded pages. In this method there is further provided an input mechanism for annotations. In this method the user enters an annotation and the notepad computer retrieves pages matching the annotation for display. Annotations are simply words or phrases attached to a page.

There are also a number of methods of editing stored pages and all are intended to be covered by present disclosure. One such method is a method whereby new information is added to a previously recorded page when the page is displayed and user writes on the writing area. As a further step in this method it may also be useful to display the position of the stylus on the screen possibly as a crosshairs cursor.

Another such method is a method whereby the user uses a pen with erasable ink equipped with an eraser at the end opposite the stylus. When the user rubs the eraser on the writing area, information underneath the eraser is removed from computer memory and the associated screen if the page is displayed. Another way to erase is to provide a special switch on the pen. Once the switch is moved to the erase position the action of the pen is to erase as opposed to record data in the computer memory.

In accordance with the first preferred embodiment of the invention, a means to indicate that a new page has been begun and that a new page should be recorded by the notepad computer is provided.

There are several methods that can facilitate such means and all are intended to be covered by present disclosure.

One such method is to provide a push button connected to the notepad computer. Whenever the button is depressed the computer begins recording of a new page. It is up to the user to start writing on a new paper sheet if the user is using paper.

In accordance with the first preferred embodiment, there is provided a means to transfer handwriting data to personal computer.

There are a number of methods or systems that can facilitate this means and all are intended to be covered by the disclosure.

Therefore, disclosed is a system to transfer contents of memory of the notepad computer to a general purpose personal computer such as a Windows PC or a Macintosh PC. This system comprises the provision of a communications link between said computer and said notepad computer. There is also provided a mechanism to initiate a transfer. There is also provided communication software that can be installed on the personal computer, this software being adapted to communicate with said notepad computer. Transfer between memory of notepad computer and a personal computer enables the user to store handwriting in an additional memory thereby decreasing chances of loss. Once handwriting information is transferred to a personal computer further editing and annotation may be possible. Providing such editing software is intended to be within the scope of the present disclosure. It will be obvious to one skilled in the art that such software can facilitate the means to retrieve, display, and edit stored handwriting information.

In accordance with the first preferred embodiment, there is provided a means to enter a search pattern and a means to search stored pages given the search pattern.

There are a number of methods or systems that can facilitate this means and all are intended to be covered by present disclosure.

An example of such methods are handwriting recognition computer algorithms that transform handwriting into words that can be stored as ASCII characters inside computer memory.

It will be obvious to one skilled in the art that once handwritten information is transformed into machine searchable format the user will be able to find pages by writing a word in the writing area and invoking a search function that will search stored pages for the word.

Another method adapted to searching handwritten information is the method of statistical comparison. This method comprises the following steps:
(1) providing a handwritten word to search for;
(2) providing an algorithm to search pages for a pattern that is a statistically similar.

It will obvious to one skilled in the art of pattern recognition that there are a number of methods that can be used to determine if two handwritten words or phrases are statistically similar. Standard methods from pattern recognition theory can be used.

A second preferred embodiment is also disclosed. The second preferred embodiment is a variation of the first preferred embodiment. FIG. 1 shows exactly four the transceivers placed around the page and exactly two the transceivers placed inside the pen, however, it will be obvious to one skilled in the art that one or more transceiver placed around the page and one or more transceiver placed inside the pen can be employed.

A third preferred embodiment is also disclosed. The third preferred embodiment is a variation of the first preferred embodiment.

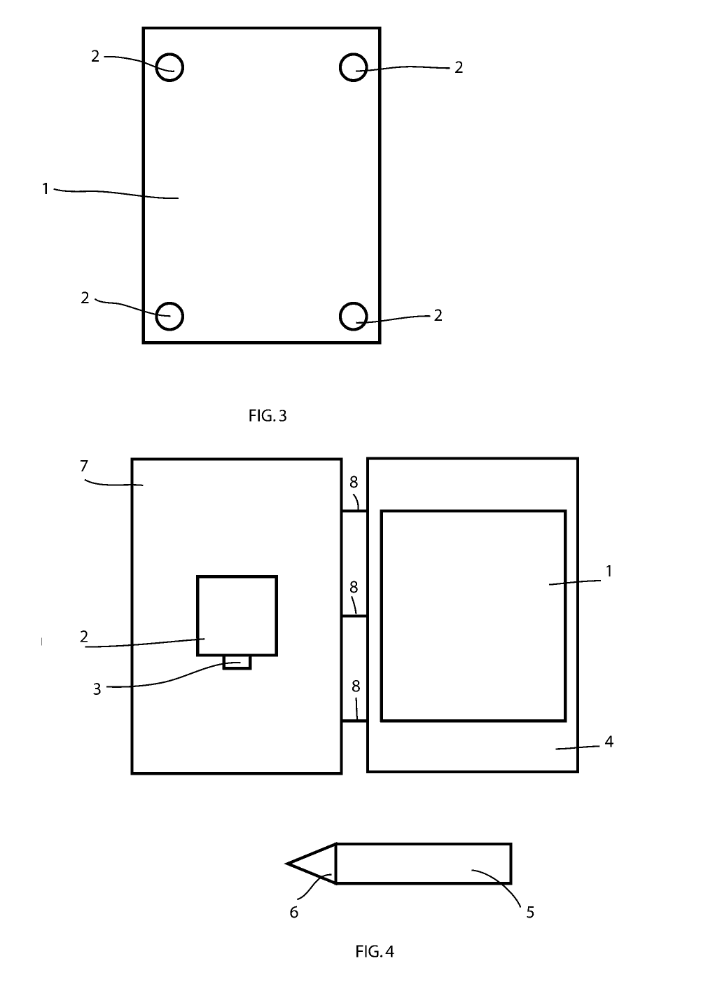

In the third embodiment of the present invention the notepad computer and screen is replaced by a personal digital assistant (PDA). PDA's such as the Palm or the Microsoft Pocket PC, or the RIM Blackberry are good substitutes for the notepad computer 1 and screen 5 in FIG. 1. This configuration is shown in FIG. 4 and is intended to be covered by present disclosure. According to FIG. 4, there is provided a system comprising a PDA 2, a PDA interface 3, a pen 5 comprising a stylus 6. As in FIG. 1, the system comprises a screen base 7 and a notepad base 4. As in FIG. 1, the system comprises bindings 8 between screen base and notepad base.

It will be obvious to one skilled in the art that the PDA interface may contain its own CPU and memory.

It will be obvious to one skilled in the art that the operation of the invention in the third preferred embodiment is the same as operation of the invention in the first embodiment except that the notepad computer has been replaced by a PDA.

A fourth preferred embodiment is also disclosed. The fourth preferred embodiment is a variation of the first preferred embodiment.

It will be obvious to one skilled in the art that the operation of the invention in the fourth preferred embodiment is the same as operation of the invention in the first embodiment except that one or more transceiver near or inside the tip of the stylus.

A fifth preferred embodiment is also disclosed. The fifth preferred embodiment is a variation of the first preferred embodiment.

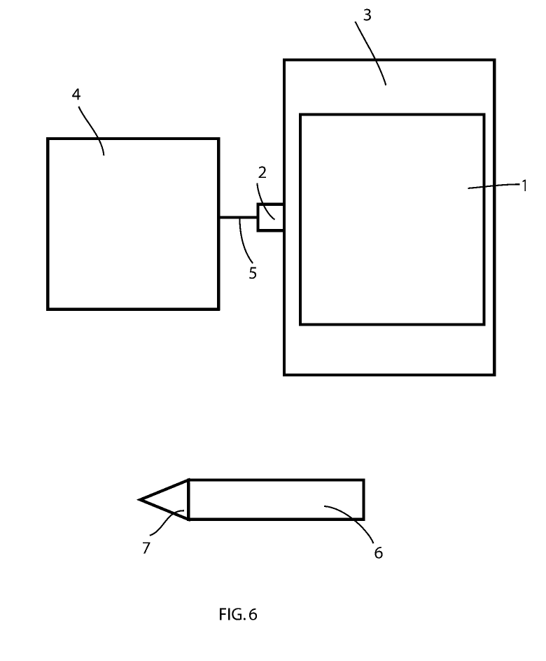

In the fifth embodiment of the invention shown in FIG. 6, the notepad computer is replaced by a general purpose personal computer 4. In this embodiment the device acts as a handwriting input device to the personal computer. The personal computer is connected to the notepad using a communications link 5 and an interface 2. The interface may contain its own memory and a CPU. According to FIG. 6, the system also comprises: a notepad base 3, a writing area 1, a pen 6, and a stylus 7 attached to the pen.

It will be obvious to one skilled in the art that the operation of the invention in this embodiment is the same as in the first preferred embodiment except that means to view and edit previously stored handwriting are facilitated using the personal computer.

A sixth preferred embodiment is also disclosed. The sixth preferred embodiment is a variation of the first preferred embodiment.

In the sixth preferred embodiment of the invention there is provided a second computer placed inside the pen adapted to calculate the position of the stylus. The second computer inside the pen communicates the position to the notepad computer outside the pen, so the notepad computer outside the pen no longer needs to communicate with the transceivers placed around the writing area. In this embodiment the function of the notepad computer depends on how much functionality can be placed inside the second computer. It will be clear however that the notepad computer must at least operate the screen. If there is no screen provided in a variation of the sixth embodiment, then it may be enough to only provide the second computer inside the pen.

It will be obvious to one skilled in the art that the operation of the invention in the sixth embodiment is the same as operation of the invention in the first embodiment except that there is a computer placed inside the pen adapted to calculate the position of the stylus.

A seventh preferred embodiment is disclosed. The seventh preferred embodiment is a variation of the first preferred embodiment.

It will be obvious to one skilled in the art that the screen in the first embodiment is not required to record what is written using the pen. The screen may be omitted in additional embodiments of the invention. Embodiments not including the screen are considered to be within the scope of the present disclosure.

It will be obvious to one skilled in the art that the operation of the invention in this embodiment is the same as operation of the invention in the first embodiment except that no screen is provided for displaying handwriting.

An eighth preferred embodiment is disclosed. The eighth preferred embodiment is a variation of the first preferred embodiment.

In the eighth embodiment, according to FIG. 1A, transceivers 9 placed in the vicinity of the writing area and the transceivers 10 placed within the pen are removed. The pressure sensor 11 inside the pen is removed as well. Further, pressure sensors are placed underneath the writing area. When activated, the pressure sensors transmit stylus position information to the notepad computer.

In accordance with the eight preferred embodiment, provided is a means to determine position of the stylus using information from the pressure sensors.

There are a number of methods or systems that can facilitate such means and all are intended to be covered by the present disclosure.

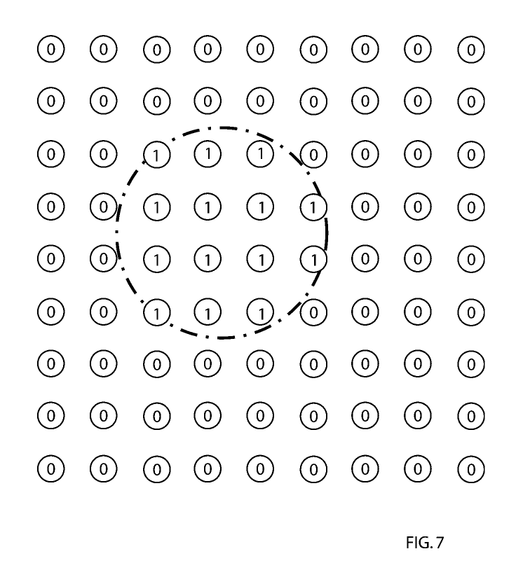

One such method, according to FIG. 7, involves the use of binary pressure sensors. In FIG. 7, the small circles represent pressure sensors that have either a 0 or a 1 inside. For illustrative purposes according to FIG. 7 if a pressure sensor has 1 that indicates that this pressure sensor has been activated due to pressure of the pen. If a pressure sensor has a 0 inside that indicates it has not been activated. According to FIG. 7, the dot-dashed circle indicates a pressure area formed by pressing the stylus onto the writing area. Pressure sensors inside the pressure area will be activated. The harder a user presses the stylus onto the writing area the larger this circle will be. It will also be clear to one skilled in the art that the pressure is infinite in radius, however, only a finite pressure area is of interest as pressure outside of the finite area is not detectable beyond a certain threshold.

Given the pattern formed by activated pressure sensors it will be obvious to one skilled in the art that the center of the pressure area can be determined. It will be obvious to one skilled in the art that the center of the pressure area is the position of the stylus.

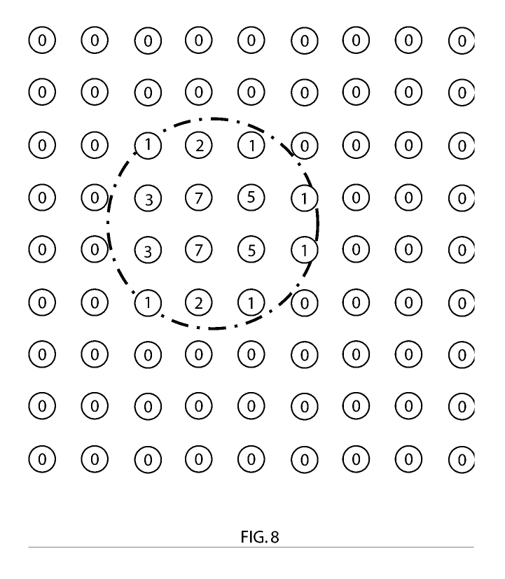

Another such method, according to FIG. 8, involves the use of multi-value or analog pressure sensors. In FIG. 8, for illustrative purposes, the small circles represent pressure sensors that have a value between 0 and 7. Sensors with the value of 7 register the highest amount of pressure whereas sensors with a 0 register the least amount of pressure. According to FIG. 8, the dot-dashed circle indicates a pressure area formed by pressing the stylus onto the writing area. Pressure sensors inside the pressure area will be activated. The harder a user presses the stylus onto the writing area the larger this circle will be. Pressure in the center of the circle will be the highest and then will decrease towards the edges with a certain distribution function. This distribution function can be determined experimentally. If the distribution function is not determined experimentally the two dimensional Gaussian distribution may be assumed.

Given the pattern formed by activated pressure sensors, and given the distribution function within the circle, it will be obvious to one skilled in the art that the center of the pressure area can be determined.

Operation of the invention in this embodiment is the same as operation of the invention in the first embodiment except that the position information of the stylus is determined using pressure sensors placed underneath the writing area.

There exist additional embodiments of the electronic notepad not described here due to the large number of combinations components used to construct disclosed invention can be arranged. However, such embodiments are intended to be covered by the present disclosure.

What is claimed is:

1. An electronic notepad system comprising:
a writing area, said writing area including a sheet of paper, paper substitute, or another sheet;
a pen comprising a stylus;
a computer comprising a CPU and a memory;
a means to store what was written in said writing area in said memory.

2. The system of [claim 1] further comprising a display adapted to displaying pages.

3. The system of [claim 1] further comprising a means to determine position of said stylus.

4. The system of [claim 1] further comprising a means to determine whether said stylus touches said writing area.

5. The system of [claim 1] further comprising a means to retrieve and display previously stored pages.

6. The system of [claim 1] further comprising a means to allow the user to indicate that a new page is being written on.

7. The system of [claim 1] further comprising a means to transfer said stored pages in said memory to a personal computer.

8. The system of [claim 7] further comprising a means to view and edit said pages using said personal computer.

9. The system of [claim 1] further comprising
a means to enter a search pattern;
search said stored pages using said search pattern.

10. The system of [claim 2] further comprising:
a first base and a second base, said bases being plates made of sturdy materials, where said display is attached to said first base and the writing area is attached to said second base;
bindings attaching said first base and said second base together, said bindings allowing said first base and said second base to be folded onto each other;
whereby an impression of a notebook is created.

11. The system of [claim 2] further comprising:
a first base and a second base, said bases being plates made of sturdy materials, where said writing area is attached to said second base;
bindings attaching said first base and said second base together, said bindings allowing said first base and said second base to be folded onto each other;
whereby an impression of a notebook without display is created.

12. The system of [claim 1] further comprising the means of sending pages stored in a first electronic notepad to a second electronic notepad for viewing using said second electronic notepad.

13. The system of [claim 1] further comprising the means to allow a user of said electronic notepad to store information stored in memory of a personal computer in memory of said electronic notepad.

14. The system of [claim 13] wherein said personal computer is adapted to print to said electronic notepad.

15. The system of [claim 1] further comprising:
a plurality of first transceivers placed inside said pen;
a pressure sensor and a transmitter paced inside said pen, said transmitter adapted to transmit the state of said pressure sensor;
a plurality of second transceivers placed around said writing area.

16. The system of [claim 15] wherein first transceivers are adapted to send or receive signals from second transceivers, further comprising:
a means to determine position of said stylus using said signals transmitted between said first and said second transceivers;
a means to determine if said stylus has been pressed against said writing area using said pressure sensor and transmitter.

17. The system of [claim 3] wherein said means to determine position of said stylus further comprises:
two or more transceivers inside said pen;
a means to determine the coordinates in three dimensions of said transceivers;
a means to determine an equation of a best fit straight line through said transceivers;
given the length of said pen a means to determine where said line crosses surface of said writing area.

18. The system of [claim 17] further comprising:
special mark spaces marked on said writing area;
a means to compute first coordinates of said mark spaces with respect to edges of said writing area;
a means to use said pen to write inside said mark spaces.

19. The system of [claim 18] further comprising:
a means to compute second coordinates of said mark spaces using said pen and said computer;
a means to adjust second coordinates to equal first coordinates;
whereby handwriting information can be recorded using a coordinate system relative to edges of said writing area.

20. The system of [claim 4] wherein said means to determine whether said stylus touches said writing area comprises:
a means of placing inside said pen a pressure sensor adapted to sensing if said stylus is pressed;
a means of placing inside said pen a transmitter adapted to transmitting the state of said pressure sensor.

21. The system of [claim 5] further comprising a scroll wheel.

22. The system of [claim 5] further comprising a scroll bar.

23. The system of [claim 5] further comprising a means of attaching annotations to previously recorded pages.

24. The system of [claim 5] further comprising a means comprising of adding new handwriting information to a previously recorded page.

25. The system of [claim 5] further comprising a means of erasing existing handwriting information from a previously recorded page.

26. The system of [claim 6] further comprising a pushbutton, said pushbutton adapted to signal to said computer that a new page has been begun.

27. The system of [claim 7] further comprising editing software on said personal computer.

28. The system of [claim 9] further comprising an algorithm adapted to transform handwriting into ASCII characters.

29. The system of [claim 9] further comprising:
a means to enable a user to enter a search pattern;
a means to find a statistical match of said search pattern inside said stored pages.

30. The system of [claim 1] wherein said computer is a PDA.

31. The system of [claim 1] wherein said computer is a personal computer.

32. The system of [claim 1] where said computer is placed within said pen.

33. The system of [claim 1] further comprising a second computer placed within said pen.

34. The system of [claim 33] wherein said second computer is adapted to compute position of said pen.

35. The system of [claim 3] further comprising a means to place plurality of pressure sensors underneath said writing area.

36. The system of [claim 35] further comprising a means to use said pressure sensors to locate the position of said stylus.

37. The system of [claim 35] wherein said pressure sensors are binary.

38. The system of [claim 35] wherein said pressure sensors are analog or digital multi-value.
